(19) United States
(12) Patent Application Publication
(10) Pub. No.: US 2003/0118168 A1
(43) Pub. Date: Jun. 26, 2003

(54) Method and system for providing call forwarding information to a calling party

(76) Inventors: Susanne Marie Crockett, Buffalo Grove, IL (US); John Wesley Moss, Lake Zurich, IL (US); Nancy Ann Book, Naperville, IL (US); Carol Shifrin Gruchala, Naperville, IL (US); Dianna Inara Tiliks, Elk Grove, IL (US); Paul H. Vlasek, Brookfield, IL (US)

Correspondence Address: BRINKS HOFER GILSON & LIONE, P.O. BOX 10395, CHICAGO, IL, 60610, US

(21) Appl. No.: 10/027,224

(22) Filed: Dec. 20, 2001

(51) Int. Cl. H04M 3/42

(52) U.S. Cl. 379/211.02

(57) ABSTRACT

A method and system are disclosed for providing an announcement to a calling party when the calling party calls a disconnected telephone number of a called party. Calling party information is provided for a determined disconnected telephone number of the called party. The information can include information about a telephone number of the calling party. An announcement is played to the calling party in accordance with the information. For example, one type of announcement is played if a telephone number of the calling party is included in the information. Otherwise an alternate announcement can be provided to the calling party.

### FIELD OF THE INVENTION

The invention relates to a system and method for providing call forwarding information to a calling party according to determined criteria.

### BACKGROUND

It is known that many telecommunication system providers allow telephone number subscribers to change their telephone numbers. A problem occurs in that calling parties calling the subscriber's previous telephone number may not be aware that the subscriber has changed to a new telephone number. To inform calling parties of the new telephone number, some telecommunication system providers offer the subscriber a known system of providing the new number to calling parties when the calling party calls the previous number. The new number can be provided as a recorded message to the calling parties.

The subscriber typically pays to have the recorded message played for a determined period of time, for example, a few months, to notify the calling parties of the new number. The message may include a forwarding number, e.g. the new number, or a blank directory number. A problem occurs in that the subscriber may be in a situation where the subscriber does not want certain calling parties to know the new number. For example, some subscribers may have changed the telephone number because the subscriber was being stalked or receiving numerous false phone calls. A problem occurs, however, in that the subscriber may want certain other calling parties to know the new number.

Thus, there is a need for a telecommunications system and a method that can address at least some of the above problems.

### BRIEF DESCRIPTION OF THE DRAWINGS

FIG. 1 is a block diagram illustrating an exemplary telecommunications system according to a preferred embodiment.

FIG. 2 is a flow chart illustrating a way to use the telecommunications system of FIG. 1 to provide messages to the calling party according to a preferred embodiment.

FIG. 3 is a screen shot of an exemplary input screen for a subscriber of the service according to a preferred embodiment.

FIG. 4 shows an exemplary call log for recording the calling party telephone number and the time of the call according to a preferred embodiment.

### DETAILED DESCRIPTION

A method and system are described of an announcement service that allows a subscriber to leave a new telephone number for specified calling parties and to leave a standard message or blank directory number for other calling parties. The method and system are part of an Advanced Intelligent Network (AIN) service. Being able to distinguish between calling parties that the subscriber wants to have the new number and other calling parties could help subscribers that are being stalked or in other situations where the person does not want everyone to know the new telephone number.

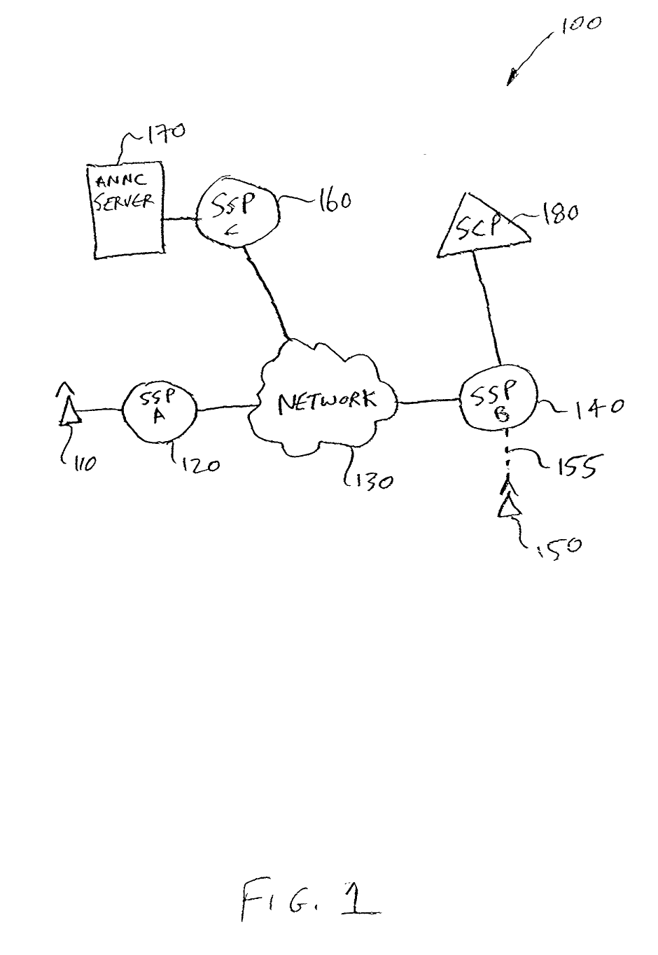

FIG. 1 is a block diagram of an exemplary telecommunications system 100 according to the preferred embodiments. A calling party 110 calls from a telephone that has a corresponding calling party telephone number associated with it. A telecommunications service provider provides a service switching point (SSP) A 120 to connect the calling party 110 to a communications network 130. The communications network 130 is part of a Public Switch Telephone Network (PSTN).

The network 130 connects to a switch, for example, SSP B 140, that connects to the subscriber, i.e. called party 150, of the disclosed system and method. The called party 150 has a corresponding called party telephone number. In this case, the called party telephone number is a previous telephone number of the called party 150 and is not currently in service. The telephone line 155 is shown as a dotted line to indicate that called telephone number is no longer in service, for example, has been disconnected. The called party 150 may have had the number changed to a new telephone number.

The network 130 can also connect to other switches, such as SSP C 160 that connect to servers such as announcement server 170. The announcement server 170 can be used to provide announcements to the calling party 110. Exemplary announcement servers include service nodes and/or Intelligent Peripherals (IP) such as an IBM RM platform or a Lucent Compact Service Node platform. To control the routing of calls and the playing of announcements to the calling party 110, the telecommunications system 100 includes a service control point (SCP) 180. The SCP 180 connects with switches of the telecommunications system 100, for example, connects with SSP B 140 that stores the disconnected telephone number of the called party 150.

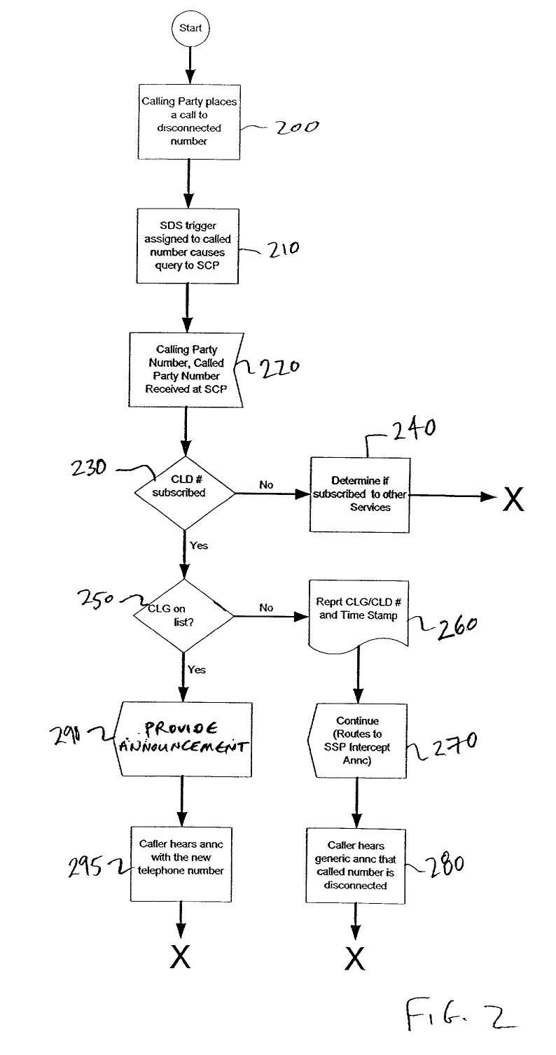

FIG. 2 is a flow chart illustrating a way for the telecommunications service provider to use the above telecommunications system 100 to provide the announcement service for the called party 150. The announcement service can be provided with an application that can be implemented with software, hardware or firmware, or any combination thereof. At block 200, the calling party 110 places a call to the previous telephone number of the called party 150. The previous telephone number is no longer a connected, i.e. working, telephone number. The called party 150 may have a new telephone number to replace the previous telephone number. The called party 150 may subscribe to the announcement service of the telecommunications service provider to notify specified calling parties 110 of the new telephone number. The called party 150 can subscribe to the service for a determined time period, for example, a few months. During the time period, the previous number remains unallocated.

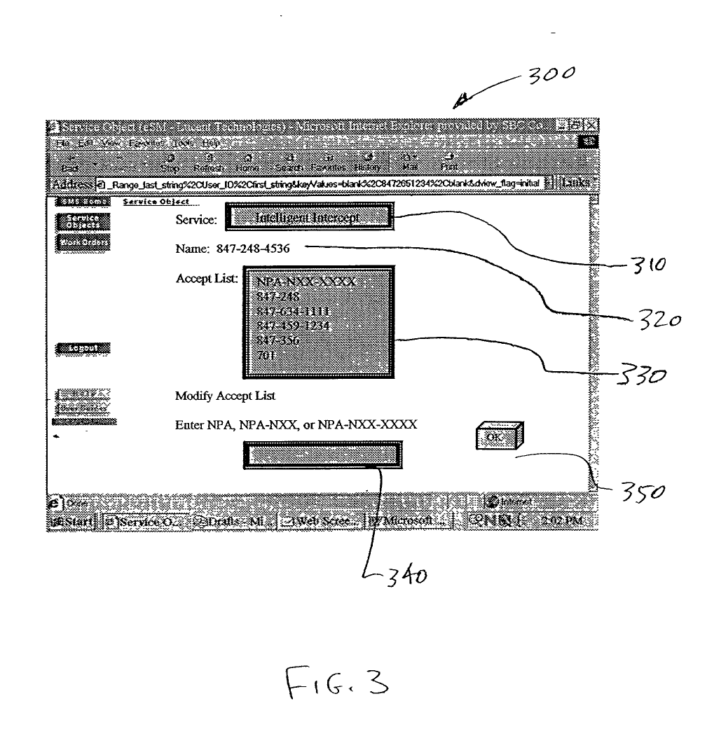

FIG. 3 is a screen shot of an exemplary input screen 300 for a subscriber called party 150 to access the service. The input screen 300 is shown in the MICROSOFT WINDOWS format, but those skilled in the art will appreciate that other operating systems could be used, such as a MACINTOSH system. The called party 150 accesses the service via the input screen 300, for example, using a World Wide Web connection to the Internet. The called party 150 can use other ways to access the service. For example, the service provider can provide an interactive voice response unit (IVRU) or other Web interface to the called party 150.

If the called party 150 accesses the service via the input screen 300, the called party 150 selects the service to update from a service field 310. A name field 320 contains a previous telephone number of the called party 150. The input screen 300 also includes a call accept list 330 for the called party to enter information regarding who should receive a message providing the new telephone number of the called party 150. The input screen 300 could also include a call reject list in addition to, or as an alternate to, the call accept list 330. Information is added to the call accept list 330 with an enter field 340. The called party 150 can enter the information in different ways. For example, the called party 150 can enter at least one of the area code, the area code plus the first three digits of a telephone number, and the area code plus the seven digits of the telephone number.

Referring also to FIG. 1, the SSP B 140 receives a call from the calling party 110 to the called party 150. Referring also to FIG. 2, at block 210, the called telephone number, which corresponds the previous telephone number of the called party 150, matches a specific digit string (SDS) stored at the SSP B 140. The SDS triggers a query to the SCP 180. At block 220, the SCP 180 receives the calling party telephone number and the called party telephone number. The calling party telephone number can be determined using, for example, SS7 signaling as part of the telecommunications system 100.

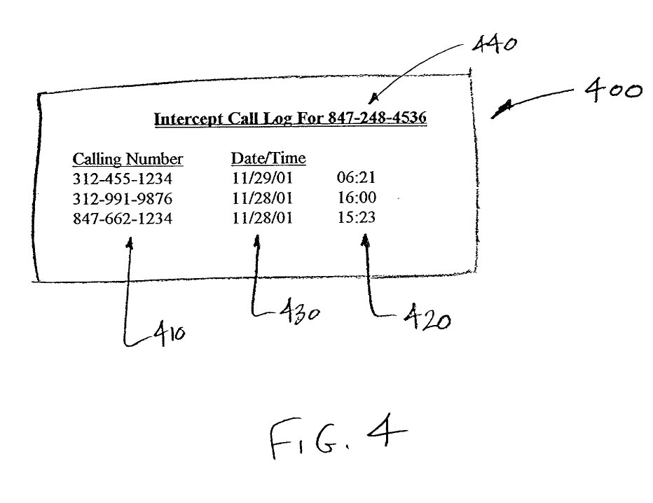

FIG. 4 shows an exemplary call log 400 for recording the calling party telephone number 410 and the time of the call 420 and date of the call 430 according to a preferred embodiment. The SCP 180 screens the calling party telephone number and performs a time stamp to record when the call was received. The time stamp preferably includes time and date information. The SCP 180 then stores the calling party telephone number and the time stamp information into a database. The database can be included with the SCP 180 and/or located away from the SCP 180 so long as the SCP 180 can write to and read from the database.

The call log information, including the calling party telephone number 410, the date 430 and the time 420 of the call for the called party telephone number 440 can be retrieved from the database and a call log report can be produced for the called party 150. The called party 150 can access the report via the Internet and/or by calling the telecommunications service provider. The called party 150 can also receive the report in other ways, for example, the telecommunications service provider can send a hard copy or an electronic copy of the report to the called party 150 at determined times.

At block 230, the announcement service application of the SCP 180 determines whether the called party telephone number is subscribed to the announcement service. At block 240, if the called party telephone number is not subscribed to the announcement service, the SCP 180 can determine whether the called party telephone number is subscribed to another service and the announcement service application ends.

If the called telephone number subscribes to the announcement service, the announcement service application determines whether the calling number is authorized to receive a forwarding number of the called party. At block 250, the announcement service application can determine whether the calling party (“CLG”) is authorized by comparing a telephone number of the calling party with a call list, for example, the call reject or accept list 330.

At block 260, if the calling party is not authorized to receive the forwarding telephone number, the calling telephone number, the called telephone (“CLD”) number and the time stamp are recorded. At block 270, the SCP 180 routes the call to the SSP B 140 to play an intercept announcement. At block 280, the played announcement can include a generic announcement such as an announcement that the called telephone number has been disconnected.

At block 290, if the calling party is authorized to receive the forwarding telephone number, the forwarding number is provided to the calling party 110. There are several ways to provide the forwarding number to the calling party 110. In one way, to play the forwarding number to the calling party, the SCP 180 can send a message, such as a Send_To_Resource message, to SSP B 140. The Send_To_Resource message can contain a destination address of the announcement server 170. The SSP B 140 sets up a connection to the SSP C and temporarily connects the calling party 110 to hear the announcement. Alternatively, the announcement server could be connected to the SSP B 140. At block 295, the announcement server 170, such as an Intelligent Peripheral, supplies the announcement to the calling party 110. The announcement can be stored on the announcement server, for example, as a .WAV file.

In another way, the SCP 180 can instruct the switch to route the calling party 110 to an announcement server, such as announcement server 170, and play a message to the calling party. The call from the calling party can be routed to the announcement server 170, such as a Service Node or Intelligent Peripheral, using an Analyze_Route message. Using the Analyze_Route message, the called telephone number is assigned the telephone number of the announcement server 170. The announcement server 170 could determine which announcement to play based on OrigninalCalledPartylD or RedirectedPartylD parameters in the Analyze_Route message The parameters are used at the platform to determine the identity of the subscriber.

Alternative to using the announcement server 170, the announcement can be stored with and played by a switch. For example, the announcement can reside at SSP B 140.

While the invention has been described above by reference to various embodiments, it will be understood that many changes and modifications can be made without departing from the scope of the invention. It is therefore intended that the foregoing detailed description be understood as an illustration of the presently preferred embodiments of the invention, and not as a definition of the invention. It is only the following claims, including all equivalents, which are intended to define the scope of this invention.

We claim:

1. A method for providing an announcement to a calling party when the calling party calls a disconnected telephone number of a called party, the method comprising:
providing a calling party information for a disconnected telephone number of the called party;
determining whether the calling party is authorized to receive a first announcement in accordance with the calling party information; and
providing the first announcement to the calling party if the calling party is authorized.

2. The method according to claim 1 further comprising providing an alternate announcement if the first announcement is not provided.

3. The method according to claim 1 wherein the calling party information includes at least a portion of a telephone number of the calling party.

4. The method according to claim 3 wherein the at least a portion of the telephone number includes an area code of the calling party.

5. The method according to claim 4 wherein the at least a portion of the telephone number further includes at least three digits of the telephone number of the calling party.

6. The method according to claim 1 wherein the calling party information comprises information about calling parties that are authorized to receive the first announcement.

7. The method according to claim 1 wherein the calling party information comprises information about calling parties that are not authorized to receive the first announcement.

8. The method according to claim 1 wherein the first announcement is provided by an announcement server.

9. The method according to claim 8 further including providing a connection from the calling party to the announcement server.

10. The method according to claim 1 further comprising providing a call log to the called party.

11. A telecommunications system for providing an announcement to a calling party when the calling party calls a disconnected telephone number of a called party, the system comprising:
a service control point, wherein the service control point accesses calling party information for a determined disconnected telephone number of the called party; and
wherein a first announcement is provided to the calling party if the calling party is authorized to receive the first announcement in accordance with the calling party information.

12. The system according to claim 11 wherein an alternate announcement is provided if the first announcement is not provided.

13. The system according to claim 1 wherein the calling party information includes at least a portion of a telephone number of the calling party.

14. The system according to claim 13 wherein the at least a portion of the telephone number includes an area code of the calling party.

15. The system according to claim 14 wherein the at least a portion of the telephone number further includes at least three digits of the telephone number of the calling party.

16. The system according to claim 11 wherein the calling party information comprises information about calling parties that are authorized to receive the first announcement.

17. The system according to claim 11 wherein the calling party information comprises information about calling parties that are not authorized to receive the first announcement.

18. The system according to claim 11 further including an announcement server, wherein the announcement server provides the first announcement.

19. The system according to claim 18 further including a switch, wherein the switch provides a connection from the calling party to the announcement server.

20. The system according to claim 11 further comprising a call log to be provided to the called party.

21. A method for providing an announcement to a calling party when the calling party calls a disconnected telephone number of a called party, the method comprising:
receiving a call from a calling party to a disconnected telephone number of a called party;
determining whether the called party is authorized to receive call forwarding information for the called party; and
if the calling party is authorized, providing call forwarding information for the called party.

22. The method according to claim 21 further comprising:
if the calling party is not authorized, providing an alternate announcement to the calling party.

23. The method according to claim 21 wherein the act of determining comprises determining whether the calling party is listed on an accept list.

24. The method according to claim 21 wherein the act of determining comprises determining whether the calling party is listed on a reject list.
